(19) United States
(12) Patent Application Publication
(10) Pub. No.: US 2006/0080387 A1
(43) Pub. Date: Apr. 13, 2006

(54) Communications network

(75) Inventors: Juha P. Sipila, Nokia (FI); Tero Taskila, Kyroskoski (FI); Sinikka Sarkkinen, Kangasala (FI); Jari Isokangas, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/236,820

(22) Filed: Sep. 28, 2005

(30) Foreign Application Priority Data
Oct. 13, 2004 (GB) 0422836.7

(51) Int. Cl. G06F 15/16

(52) U.S. Cl. 709/203

(57) ABSTRACT

This invention relates to a communications network, comprising a first network controller, a second network controller and a proxy function, said proxy function being arranged when control of user equipment is to change from said first network controller to said second network controller to cause said first network controller to release resources associated with said first controller.

### FIELD OF THE INVENTION

The present invention relates to a method for communications network.

### BACKGROUND OF THE INVENTION

The coverage area of a cellular radio communication system, such as GSM (Global System for Mobile Communications) and UMTS (Universal Mobile Telecommunication System), is made up of individual cells. A cell can be defined as a specific geographical area where radio access is supplied by a base station (BS) associated with the cell. The base station thus provides radio access to all mobile stations located within the cell.

Several cells may be grouped together and the respective base stations associated with respective ones of the cells in the group are controlled by a radio network controller (RNC). An RNC can therefore control communications with a mobile station located within one of its associated cells. In a Universal Mobile Telecommunication System (UMTS) network, the RNCs are connected to gateway elements, such as a mobile switching centre (MSC) and a serving GPRS (General Packet Radio Service) support node (SGSN). The MSC and SGSN are part of the core network (CN), and provide circuit switched and packet switched services. Specifically, the MSC can be used to provide circuit switched services and can be connected to circuit switched networks, such as a public switched telephone network (PSTN). The SGSN can provide packet switched services and can be connected to a gateway GPRS support node (GGSN). The GGSN can be connected to packet switched networks, such as the Internet or another UMTS network.

When the mobile station moves from one cell to a new cell, the base station associated with the new cell may be controlled by a different RNC, the target RNC, to that of the original cell, the source RNC. Two situations can arise.

In the first situation, control of the MS is retained by the source RNC, and traffic is routed from the target RNC to the source RNC using the inter-RNC interface (lur interface). The connection to the source RNC is therefore maintained, and control of communications is also maintained by the source RNC. This procedure is commonly referred to as anchoring.

In the second situation, control of the MS by the source RNC is released and control of communications is transferred completely to the target RNC associated with the cell where the MS has moved to. The target RNC thus becomes the new source RNC after communication has been transferred. This procedure is referred to as serving radio network subsystem (SNRS) relocation.

Entities in the core network are involved in SRNS relocation. In particular, information relating to relocation is transmitted to and received from the core network to effect SRNS relocation. However, this is not always desirable as the core network, or the network operator of the core network, may not necessarily support SRNS relocation. This may be the case even if SRNS relocation is preferable for the RNCs that would be involved.

If a there is a cluster of RNCs, relocation may be required because the UE controlling function is CPU and memory intensive and it is necessary to balance the load between different RNCs. The core network should not be involved in this case because the relocation is only due to UTRAN (UMTS terrestrial radio access network) internal capacity reasons and there are no mobility issues involved.

Furthermore, if there is more than one RNC that can be used to control communications, SRNS relocation may help distribute communications resources, such as bandwidth, more effectively and increase the overall internal capacity of the network. However, it has previously not been feasible to involve the core network in SRNS relocation for capacity reasons.

This is because this may dramatically increase the number of relocations and if the core network is involved, this may burden the SGSN or MSC too much. Additionally it is undesirable to involve the core network in UTRAN internal capacity issues.

In short, current SRNS relocation procedures do not include the possibility of relocation without the involvement of the CN.

### SUMMARY OF THE INVENTION

It is the aim of embodiments of the present invention to address one or more of the above discussed problems.

According to one aspect of the present invention, there is provided a communications network, comprising a first network controller, a second network controller and a proxy function, said proxy function being arranged when control of user equipment is to change from said first network controller to said second network controller to cause said first network controller to release resources associated with said first controller.

According to a second aspect of the present invention, there is provided a method of changing from a first network controller associated with a user equipment to a second network controller, the method comprising the steps of determining that control of the user equipment by the first network controller is to be changed to the second network controller; and using a proxy function to cause said first network controller to release resources associated with said first controller.

According to a third aspect of the present invention; there is provided a proxy function in a communications network comprising a first network controller and a second network controller, said proxy function being arranged when control of user equipment is to change from said first network controller to said second network controller to cause said first network controller to release resources associated with said first controller.

### BRIEF DESCRIPTION OF THE DRAWINGS

For a better understanding of the present invention, reference will now be made, by way of example only, to the accompanying drawings, in which:

FIG. 1 illustrates a schematic diagram of a cellular communication system;

FIG. 2 illustrates a communication system of the prior art;

FIG. 3 illustrates a message flow diagram in an example of a relocation procedure;

FIG. 4 illustrates a communication system in an example of the present invention; and

FIG. 5 illustrates a signalling flow in an embodiment of the present invention.

### DESCRIPTION OF THE PREFERRED EMBODIMENTS

The present invention is described herein with reference to particular examples. The invention is not, however, limited to such examples. In particular, the invention is described by way of reference to an exemplary UMTS network. However it should be appreciated that embodiments of the present invention may be used with any other suitable communications network.

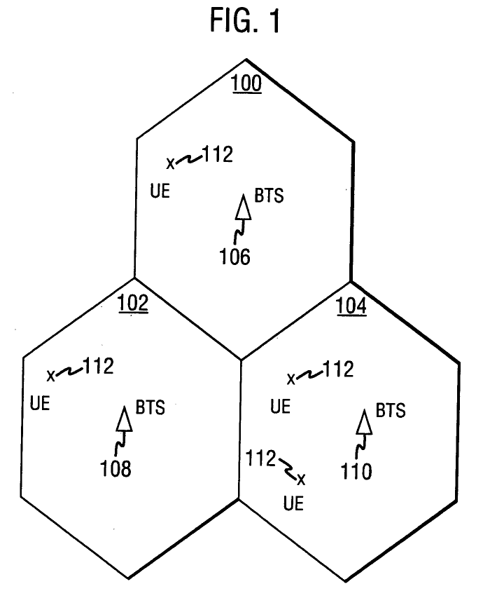

Reference is first made to FIG. 1, in which 3 cells 100, 102 and 104 of a typical cellular GSM/UMTS network are shown. Each cell 100, 102 and 104 is served by a respective base transceiver station (BTS) 106, 108 and 110. Each BTS is arranged to transmit signals to and receive signals from user equipment (UE) 112 located in the cell associated with the BTS. Examples of UEs include mobile stations, personal digital assistants (PDAs), computers and other suitably configured devices. Each UE 112 can move from one cell to another cell.

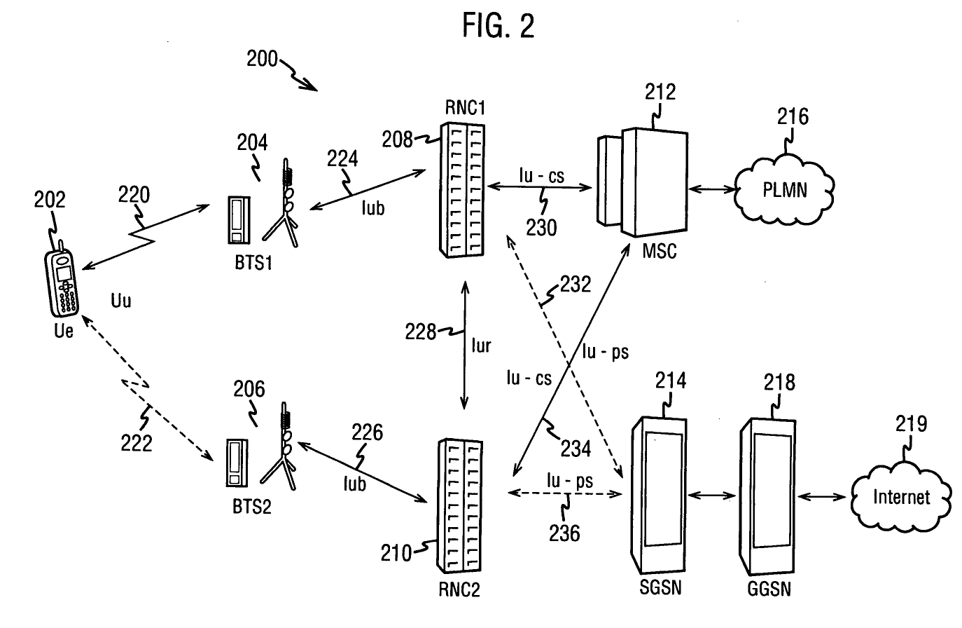

The operation of the exemplary network in FIG. 1 is now described in more detail with reference to FIG. 2 which is known.

FIG. 2 illustrates a UMTS network 200. The network 200 comprises various network elements including UE 202, BTS1 204 and BTS2 206. BTS1 204 and BTS2 206 are each associated with a respective cell. The UE 202 communicates with BTS1 204 over the Uu interface 220 when located within the cell associated with BTS1. The UE 202 can also communicate with BTS2 206 over the Uu interface 222 when located within the cell associated with BTS2 206. Further, BTS1 204 is connected to radio network controller 1 (RNC1) 208 via lub interface 224, and BTS2 206 is connected to radio network controller 2 (RNC2) 210 via lub interface 226. More than one BTS can be connected to each RNC, although only one is illustrated here for clarity.

RNC1 208 and RNC2 210 can communicate with each other directly via lur interface 228. RNC1 208 and RNC2 210 can also communicate with a mobile switching centre (MSC) 212 and a serving GPRS support node (SGSN) 214. The MSC 212 and the SGSN 214 form part of the core network (CN). Other entities not illustrated in FIG. 2, such as a home location register, may also be found in the CN.

Communication between RNC1 208 and MSC 212 is via the lu-cs interface 230. Communication between RNC2 210 and MSC 212 is via the lu-cs interface 234. The MSC 212 provides support for circuit switched services and can be connected to circuit switched networks, such as a public land mobile network (PLMN) 216. The MSC 212 can also be connected to other circuit switched networks not illustrated such as a public switched telephone network (PSTN).

Communication between RNC1 208 and SGSN 214 is via the lu-ps interface 232. Communication between RNC2 210 and SGSN 214 is via the lu-ps interface 236.

The SGSN 214 provides support packet switched services and can be connected to a gateway GPRS support node (GGSN) 218 and onto the Internet 219 or other packet data network. The GGSN 218 can also or alternatively be connected to other packet switched networks not illustrated such as another UMTS network.

In FIG. 2, the UE 202 is initially in a cell supported by BTS1 204. Communications between the UE 202 and BTS1 204 is over the Uu interface 220, illustrated by the solid line. UE 202 may move into a new cell supported by BTS2 206, in which case, UE 202 may begin communications with BTS2 206 over Uu interface 222, illustrated by the dashed line. In a procedure referred to as serving radio network subsystem (SRNS) relocation, control of communications passes from RNC1 208, which controls BTS1 204, to RNC2210, which controls BTS2 206. RNC1 208 is often referred to as the source RNC and RNC2 210 as the target RNC during SRNS relocation.

Once all control has been passed from the source RNC to the target RNC, the target RNC becomes the new source RNC until a further SRNS relocation procedure is carried out.

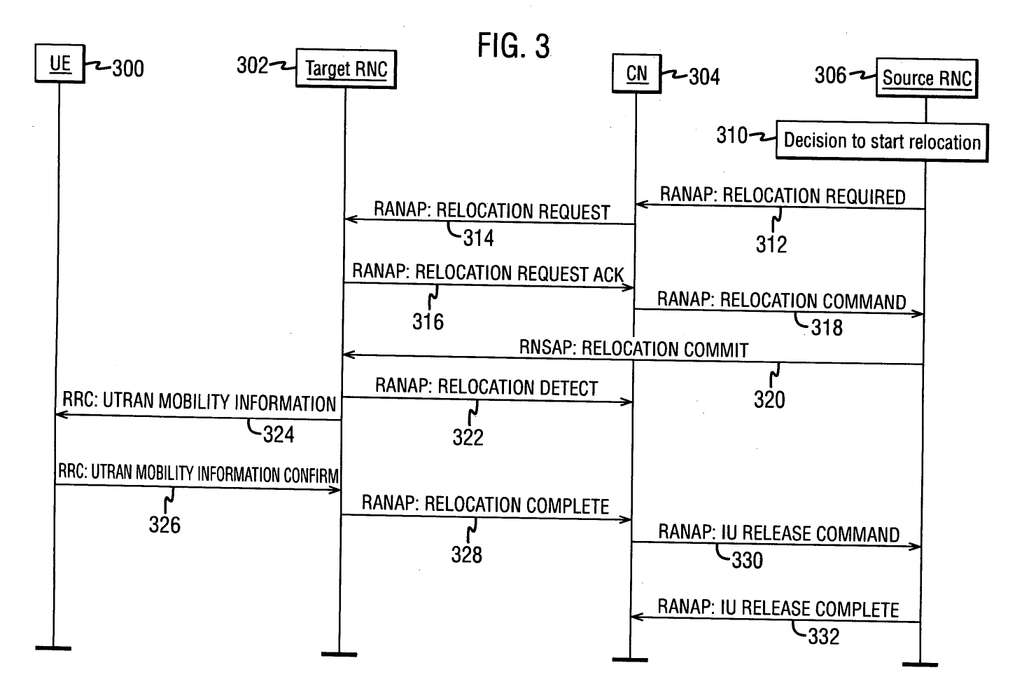

Entities in the core network, such as the MSC 212 and the SGSN 214, are used in the SRNS relocation procedure. FIG. 3 illustrates a message flow diagram of a relocation procedure of the prior art involving the core network.

In the core network, a MSC and a SGSN are used. The MSC is involved if the user has CS radio bearers and the SGSN if the user has PS bearers. Both will be involved in the case where there are both CS and PS radio bearers. The MSC and/or SGSN are involved because the termination point of the lu connection will change if the RNC changes.

The message flow in FIG. 3 is between the network elements of the UE 300, the target RNC 302, the core network (CN) 304 and a source RNC 306.

In step 310, the source RNC 306 makes a decision to start relocation to the target RNC 302. This may be triggered by the UE 300 moving into a cell controlled by the target RNC and may be further dependent on parameters such as signal strength.

Once relocation is started, the source RNC 306 transmits a radio access network application part (RANAP) relocation required message, step 312, to the CN 304. The CN 304 then transmits a RANAP relocation request message to the target RNC 302 in step 314.

If the target RNC 302 is able to support relocation, it transmits a RANAP relocation request acknowledgement message back to the CN 304 in step 316. The CN 304 then transmits a RANAP relocation command to the source RNC 306 in step 318, which informs the source RNC 306 that relocation can continue.

The source RNC 306 then transmits a radio network subsystem application part (RNSAP) relocation commit message to the target RNC in step 320. This message is transmitted directly between the source RNC 306 and the target RNC 302 via an lur interface. The commit message is a notification to a target RNC that the source RNC has received the relocation command message and the control can be switched from the source RNC to the target RNC. After the SRNC has sent the commit message, the relocation cannot be cancelled. The commit message includes all direct transfer messages that have been received in the SRNC after relocation was started. In the case of lossless relocation, there will be PDCP and GTP sequence numbers but this in practice may be rare occurrence.

The target RNC 302 then transmits a RANAP relocation detect message to th CN 304 instep 322 to confirm to the CN 304 that the target RNC has received the RNSAP message from step 320. Furthermore, the target RNC 302 also transmits a radio resource control (RRC) message to the UE 300 in step 324. The RRC message is transmitted via the BTS serving the UE in the target cell. The RRC message contains UTRAN (UMTS terrestrial radio access network) mobility information required for the relocation.

In step 326, the UE 300 transmits a RRC UTRAN mobility information confirm message to the target RNC 302. In turn, the target RNC transmits a RANAP relocation complete message in step 328 to the CN 304.

The CN 304 then transmits a RANAP lu release command message to the source RNC 306 in step 330, instructing the source RNC 306 to release control of communications between the source RNC 306 and the UE 300. The source RNC 306 confirms release by transmitting a RANAP lu release complete message instep 332. SRNS relocation is now complete.

It should be appreciated that the UE involved in the SRNC relocation is not a handover as such as the UE already has a connection to the TRNC—the drift link. The UE is involved about the change of the controlling RNC with the message sent in step 324. When the UE receives this message it will do the following:

1. change U-RNTI—this needs to be done because the U-RNTI is RNC specific and the RNC has changed.

2. reset the RLC sequence numbers—new RLC entities are created in the TRNC so the sequence numbering must start from 0.

3. reset ciphering counters,

When the target RNC sends a the relocation detect message, the CN startst to transmit data to the new RNC and when the target RNC sends the relocation complete message the CN shall release the source RNC. After this the relocation is successfully over.

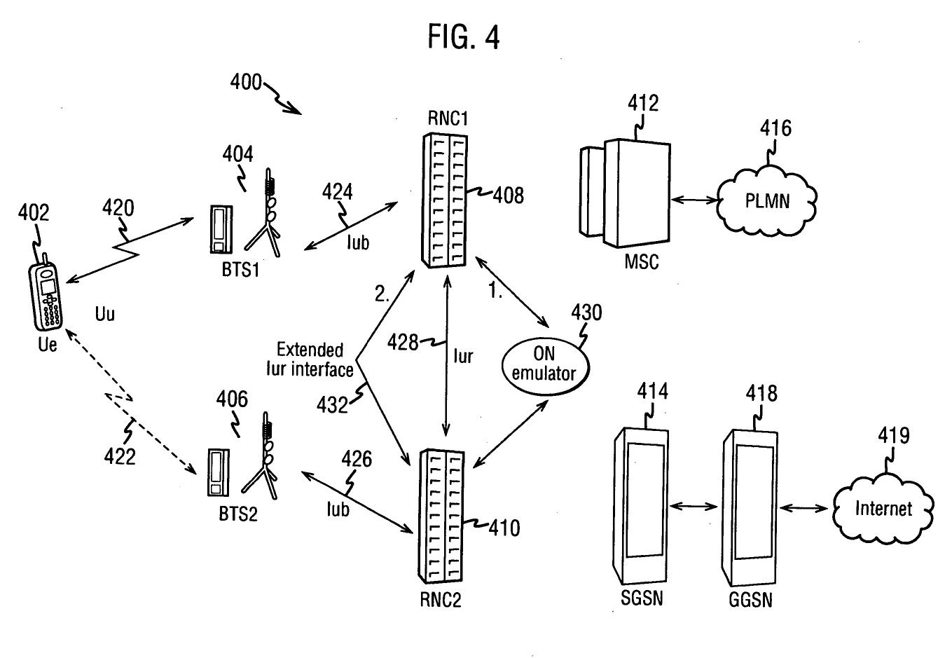

An example of the present invention will now be described with reference to FIG. 4.

FIG. 4 illustrates a GMS/UMTS network 400 embodying the present invention. The network 400 comprises various network elements including UE 402, BTS1 404 and BTS2 406. BTS1 404 and BTS2 406 are each associated with a respective cell. The UE 402 communicates with BTS1 404 over the Uu interface 420 when located within the cell associated with BTS1 404. The UE 402 can also communicate with BTS2 406 over the Uu interface 422 when located within the cell associated with BTS2 406. Further, BTS1 404 is connected to RNC1 408 via lub interface 424, and BTS2 406 is connected to RNC2 410 via lub interface 426. More than one BTS can be connected to each RNC, although only one is illustrated here for clarity.

RNC1 408 and RNC2 410 can communicate with each other directly via lur interface 428. RNC1 408 and RNC2 410 can also communicate with a mobile switching centre (MSC) 412 and a serving GPRS support node (SGSN) 414. The MSC 412 and the SGSN 414 form part of the core network (CN). Other entities not illustrated in FIG. 4, such as a home location register, may also be found in the CN.

Communication between RNC1 408 and MSC 412 may be via a lu-cs interface (not illustrated). Communication between RNC2 410 and MSC 412 may also be via a lu-cs interface (not illustrated). The MSC 412 provides support for circuit switched services and can be connected to circuit switched networks, such as a public land mobile network (PLMN) 416. The MSC 412 can also be connected to other circuit switched networks not illustrated such as a public switched telephone network (PSTN).

Communication between RNC1 408 and SGSN 414 may be via the lu-ps interface (not illustrated). Communication between RNC2 410 and SGSN 414 may be via the lu-ps interface 36 (not illustrated). The SGSN 214 provides support packet switched services and can be connected to a gateway GPRS support node (GGSN) 218 and onto the Internet 219. The GGSN 218 can also be connected to other packet switched networks not illustrated such as another UMTS network.

In FIG. 4, the UE 402 is initially in a cell supported by BTS1 404. Communications between the UE 402 and BTS1 404 is over the Uu interface 420, illustrated by the solid line. UE 402 may move into a new cell supported by BTS2 406, in which case, UE 402 may begin communications with BTS2 406 over Uu interface 422, illustrated by the dashed line. In SRNS relocation, control of communications passes from RNC1 408, which controls BTS1 404, to RNC2 410, which controls BTS2 406. During SRNS relocation, RNC1 408 is often referred to as the source RNC and RNC2 410 as the target RNC. Once control of communications has been passed from the source RNC to the target RNC, the target RNC becomes the new source RNC until a further SRNS relocation.

In an example of the present invention, the core network, such as the MSC 412 and the SGSN 414, are not used in the SRNS relocation procedure, unlike the procedure illustrated in FIG. 2. Instead, a core network proxy is provided. This may be a separate core network proxy 430 or may be provided as part of one or more RNCs.

Thus, a dummy core network process can be introduced, which emulates the functionality of the existing core network. This may be implemented in the source RNC or the target RNC, and the messages sent between the source RNC and the target RNC may be transmitted via a modified interface. Alternatively a separate CN proxy is introduced which is able to receive messages from and send messages to the RNCs.

Thus either of the RNCs works as a CN proxy or there is a separate proxy server 430. More particularly, the RNCs or proxy server are arranged to emulate the functionality of the MSC and/or SGSN which would be provided in RNC relocation.

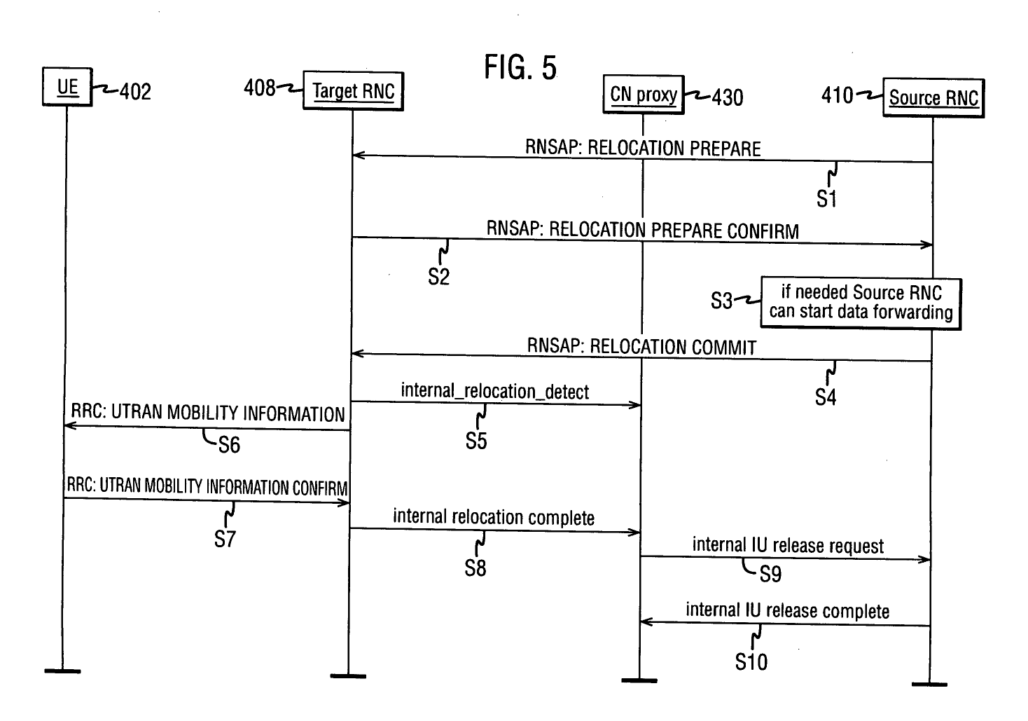

Reference is now made to FIG. 5 which shows the signalling in an embodiment of the invention which uses a core network proxy function. As mentioned, the core network proxy can be a separate entity or part of the target RNC or source RNC.

In step S1, the source RNC sends a RNSAP message relocation prepare to the target RNC 408. This is so that new control resources for the user equipment are created at the target RNC. The required information about the old context is sent in this message.

In step S2, the target RNC 408 replies to the source RNC 410 with the RNSAP message relocation prepare confirm. This message confirms to the SRNC that the TRNC has created the control resources.

In step S3, the SRNC may now start to forward data to the target RNC. This is coordinated with the CN proxy 430. It should be appreciated that this step is optional and in some embodiments of the invention may be omitted.

In step S4, the SRNC sends a RNSAP: relocation commit message to the target RNC. This confirms that the control can be switched from the SRNC to the target RNC. For the avoidance of confusion, the target RNC is now acting as a source RNC but will for the purposes of clarity continue to be referred to as the TRNC.

In step S5, the target RNC 408 sends an internal relocation detect message to the CN proxy 450. This confirms to the CN proxy 430 that the target RNC has received the relocation commit message. The proxy will delete the old internal lu connection to the old SRNC.

In step S6, the SRNC sends a RRC UTRAN mobility information message to the UE. This is as in step 324 of FIG. 2.

In step S7, the UE replies to the TRNC with a RRC message—UTRAN mobility information confirm. This is as in step 326 of FIG. 2.

In step S8, the TRNC 408 sends a internal relocation complete message to the CN proxy 430.

In step S9, the CN proxy sends an internal IU release request to the SRNC. This requests that the SRNC delete the old resources.

In step S10, the source RNC sends to the CN proxy 430 an internal IU release complete message confirming that the SRNC has successfully completed the deletion of old resources.

In embodiments of the invention relay RANAP is used because the lu interface signalling cannot be reallocated. The lu user plane will be switched with means of ATM re-routing. Thus after relocation, the proxy entity is able to pass the data received to/from the IU to the new source RNC, ie to the TRNC.

In some embodiments of the invention, the introduction of the emulated CN proxy may be advantageous when introducing clustered RNCs because the modifications to the existing implementations may be minimal.

The above described arrangement results in several advantages over prior art arrangements.

Firstly, user equipment can be relocated between RNCs without the need for the involvement or support of the CN. This is important as not all CN operators currently support SRNS relocation, which is considered as an important mobility issue.

Furthermore, SRNS relocation may be performed for capacity reasons within a cluster of RNCs, which can be done quickly as there is no need for CN to be involved. This also saves on CN resources.

It should be appreciated that the transmission costs between the proxy and the RNC are not considered to be an issue because the cluster is designed to have efficient internal transmission medias.

It is also noted herein that while the above describes exemplifying embodiments of the invention, there are several variations and modifications which may be made to the described embodiments without departing from the scope of the present invention as defined in the appended claims. One skilled in the art will recognise modifications to the described embodiments.

1. A communications network, comprising:
a first network controller;
a second network controller; and
a proxy function, said proxy function being arranged when a control of a user equipment is to change from said first network controller to said second network controller to cause said first network controller to release resources associated with said first network controller.

2. A system as claimed in claim 1, wherein said proxy function is provided externally of a core network.

3. A system as claimed in claim 1, wherein said proxy function comprises a proxy server.

4. A system as claimed in claim 3, wherein said proxy server is connected to said first and second network controllers.

5. A system as claimed in claim 1, wherein said proxy function is provided by at least one of said first and second network controllers.

6. A system as claimed in claim 5, wherein said first and second network controllers are connected together such that said proxy function in one of said first and second network controllers is arranged to communicate with another of said first and second network controllers.

7. A system as claimed in claim 1, wherein said proxy function is arranged to send a message to said first controller instructing said first network controller to release said resources.

8. A system as claimed in claim 7, wherein said first network controller is arranged to release said resources in response to said message.

9. A system as claimed in claim 7, wherein proxy function is arranged to send said message when said proxy function receives a further message indicating that said user equipment is associated with said second network controller.

10. A system as claimed in claim 9, wherein said second controller is arranged to send said further message.

11. A system as claimed in claim 1, wherein said first network controller and second network controller comprise radio network controllers.

12. A method of changing from a first network controller associated with a user equipment to a second network controller, the method comprising the steps of:
determining a change from a control of the user equipment by the first network controller to the second network controller; and
using a proxy function to cause said first network controller to release resources associated with said first controller.

13. A method as claimed in claim 12, further comprising the step of:
providing said proxy function externally of a core network.

14. A method as claimed in claim 12, further comprising the step of:
providing said proxy function in a form of a proxy server.

15. A method as claimed in claim 14, further comprising the step of:
connecting said proxy server to said first and second network controllers.

16. A method as claimed in claim 12, further comprising the step of:
providing said proxy function in at least one of said first and second network controllers.

17. A method as claimed in claim 16, further comprising the step of:
connecting said first and second network controllers together such that said proxy function in one of said network controllers is arranged to communicate with the other of said network controllers.

18. A method as claimed in claim 12, further comprising the step of:
sending, from said proxy function, a message to said first controller instructing said first network controller to release said resources.

19. A method as claimed in claim 18, further comprising the step of:
releasing said resources by said first controller in response to said message.

20. A method as claimed in claim 18, further comprising the step of:
sending said message when said proxy function receives a further message indicating that said user equipment is associated with said second network controller.

21. A method as claimed in claim 20, further comprising the step of:
sending from said second controller said further message.

22. A proxy function in a communications network comprising a first network controller and a second network controller, said proxy function being arranged when a control of a user equipment is to change from said first network controller to said second network controller to cause said first network controller to release resources associated with said first network controller.

23. A proxy server in a communications network comprising a first network controller and a second network controller, the proxy server comprising:
a proxy function being arranged when a control of a user equipment is to change from said first network controller to said second network controller to cause said first network controller to release resources associated with said first network controller.

24. A radio network controller in a communications network comprising a first network controller and a second network controller, the radio network controller comprising:
a proxy function being arranged when a control of a user equipment is to change from said first network controller to said second network controller to cause said first network controller to release resources associated with said first network controller.
